(19) United States
(12) Patent Application Publication
(10) Pub. No.: US 2025/0265456 A1
(43) Pub. Date: Aug. 21, 2025

(54) UPDATING TRANSFORMER MACHINE LEARNING MODELS TO ACCOUNT FOR RELATIVE TIMING

(71) Applicant: Capital One Services, LLC, McLean, VA (US)

(72) Inventor: Samuel SHARPE, Cambridge, MA (US)

(73) Assignee: Capital One Services, LLC, McLean, VA (US)

(21) Appl. No.: 18/443,165

(22) Filed: Feb. 15, 2024

(51) Int. Cl. G06N 3/08; G06N 3/045

(52) U.S. Cl. CPC G06N 3/08; G06N 3/045

(57) ABSTRACT

Methods and systems are described herein for updating transformer machine learning models to account for relative timing within data. The system may retrieve a transformer model trained based on events. The events may include a first event associated with a first time and second events associated with second times. The system may generate event embeddings for the events. The system may input, into the transformer model, the event embeddings to cause the transformer model to perform a transformation on the event embeddings. The system may determine respective time differences between the first time of the first event and each corresponding second time of the second events. The system may generate attention values by aggregating the transformation and the respective time differences. The system may then update the transformer model with the attention values.

### BACKGROUND

In recent years, the use of artificial intelligence, including, but not limited to, machine learning, deep learning, etc. (referred to collectively herein as artificial intelligence models, machine learning models, or simply models), has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and perform real-time determinations. However, despite these benefits and despite the wide-ranging number of potential applications, practical implementations of artificial intelligence have been hindered by technical limitations. For example, transformers have become increasingly popular in machine learning. For natural language processing (NLP), transformers are able to process large sequences of language data in parallel and capture long-range dependencies within text, making them exceptionally powerful at understanding and generating human language. However, transformers lack the ability to understand relative timing within data and rely on the relative timing when generating predictions. An understanding of relative timing within data is imperative for adapting transformers to work in contexts outside of NLP. This technical limitation may present an inherent problem with attempting to use transformer models, for example, to predict events associated with human behavior.

### SUMMARY

Methods and systems are described herein for facilitating updates to transformer machine learning models. In particular, the methods and systems facilitate updating transformer machine learning models to account for relative timing of events within data.

Existing transformer systems lack the technical ability to account for relative timing between events. For example, existing transformers excel at capturing long-range dependencies within data and generating realistic text by predicting which word should follow in a sequence of words. While transformers are able to understand word position and sentence structures, relative timing within the data is not relevant in the context of NLP. However, in other contexts (e.g., predicting events associated with human behavior), an understanding of relative timing within the data is crucial to a model's ability to generate accurate predictions of which events may occur and when they may occur. Adapting transformer models to account for relative timing within data faces technical challenges. For example, initial attempts to update transformer models to account for relative timing within data have involved statically adjusting, at each layer, how the model relies on the data based on positions of events within the data. This method requires the updates to be re-calculated for each layer of the model. Moreover, the positional information may lack the precision necessary to reflect relative timing, leading to the generation of inaccurate predictions.

To overcome these technical deficiencies in adapting transformer models to account for relative timing within data, methods and systems disclosed herein update attention values relied upon by transformer models so that the attention values account for relative timing between events. For example, the methods and systems may update attention values for a transformer model by subtracting, from corresponding event embeddings, respective time differences between those events. This enables the system to apply a single update calculation to every layer of the transformer model. Furthermore, the respective time difference between events is a precise measure of relative timing that improves the accuracy of predictions generated by transformer models in this context. Accordingly, transformer models may be adapted to model human behavior by predicting which events may occur, including the order and relative timing of events.

In some aspects, the transformer updating system retrieves a transformer model trained based on events. The events may include a first event associated with a first time and second events associated with second times. The second events may be assessed based on how much a transformer model focuses on each second event when predicting the first event. The transformer updating system may generate event embeddings including a first event embedding corresponding to the first event and second event embeddings corresponding to the second events. The transformer updating system may input, into the transformer model, the event embeddings to cause the transformer model to perform a transformation on the event embeddings. For example, the transformation may include calculating a dot product of the first event embedding with each of the second event embeddings. The transformer updating system may then determine respective time differences between the first time of the first event and each corresponding second time of the second events. The transformer updating system may generate attention values for the transformer model by subtracting, from the dot products, a function of the respective time differences. Each attention value may indicate a weight of a corresponding second event relative to the first event. Each attention value may thus account for a respective time difference between the first time and a corresponding second time. The transformer updating system may then update the transformer model with the attention values.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for updating transformer machine learning models to account for relative timing, in accordance with one or more embodiments.

FIG. 2 illustrates an exemplary machine learning model, in accordance with one or more embodiments.

FIG. 3 illustrates event embeddings, in accordance with one or more embodiments.

FIG. 4 illustrates an attention matrix, in accordance with one or more embodiments.

FIG. 5 illustrates operations performed on a row of an attention matrix, in accordance with one or more embodiments.

FIG. 6 illustrates a computing device, in accordance with one or more embodiments.

FIG. 7 shows a flowchart of the process for updating transformer machine learning models to account for relative timing, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

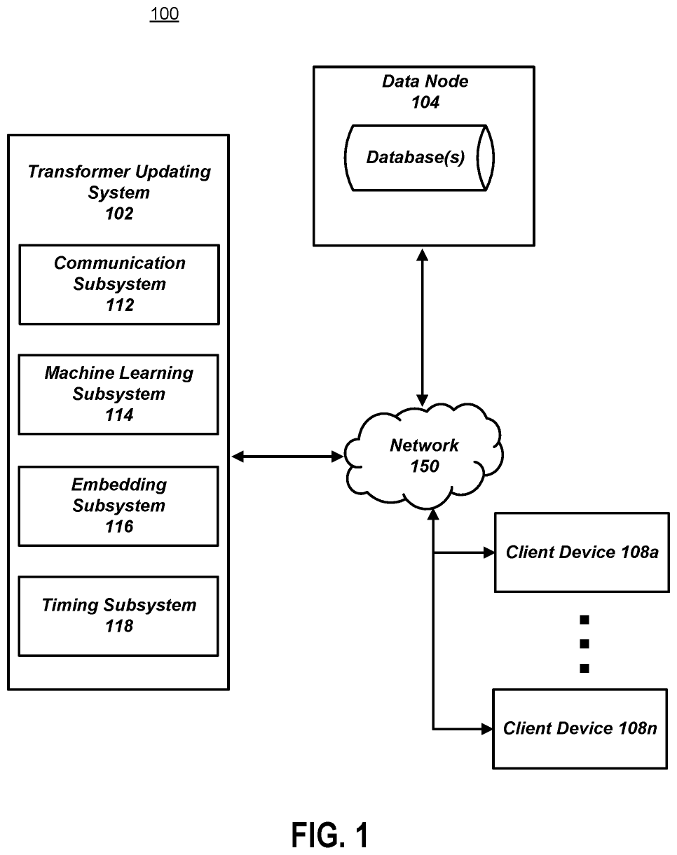

FIG. 1 shows an illustrative system 100 for updating transformer machine learning models to account for relative timing, in accordance with one or more embodiments. System 100 may include transformer updating system 102, data node 104, and client devices 108a-108n. Transformer updating system 102 may include communication subsystem 112, machine learning subsystem 114, embedding subsystem 116, timing subsystem 118, and/or other subsystems. In some embodiments, only one client device may be used, while in other embodiments, multiple client devices may be used. Client devices 108a-108n may be associated with one or more users. Client devices 108a-108n may be associated with one or more user accounts. In some embodiments, client devices 108a-108n may be computing devices that may receive and send data via network 150. Client devices 108a-108n may be end-user computing devices (e.g., desktop computers, laptops, electronic tablets, smartphones, and/or other computing devices used by end users). Client devices 108a-108n may output (e.g., via a graphical user interface) run applications, output communications, receive inputs, or perform other actions.

In some aspects, transformer updating system 102 may retrieve a transformer model trained based on input events, such as events relating to a person's behavior over time. The transformer model may be trained to model and predict events (e.g., actions, activities, transactions, or other events) associated with a person based on a sequence of events performed by the person in the past. Transformer updating system 102 may generate event embeddings for input events. Each event embedding may encapsulate information such as the time and location of an event associated with the person, its participants, its type or category (e.g., credit card transaction, default, cancellation of a card, credit check, etc.), and other relevant contextual details. The transformer may perform a transformation on each embedding and may generate an attention matrix using the transformations. Generating attention values within the attention matrix may involve adjusting the transformations according to respective time differences between corresponding pairs of events. For example, the events may include a person defaulting on a payment, making various other payments, checking their account, chatting with customer service, and performing other actions. In some embodiments, a first attention value may represent a similarity between a first embedding (e.g., representing the person defaulting on a payment) and a second embedding (e.g., representing the person making a different payment), adjusted for a first time difference between the person defaulting on the payment and making the different payment. A second attention value may represent a similarity between the first embedding (e.g., representing the person defaulting on a payment) and a third embedding (e.g., representing the person checking their account), adjusted for a second time difference between the person defaulting on the payment and checking their account, and so on. Transformer updating system 102 may update the transformer model using the attention values so that the transformer model learns to place less weight on events that occurred farther apart in time and to rely more heavily on events that occurred closer together in time. This updating enables transformer models to adapt to contexts in which understanding the relative timing of data is crucial to a transformer's ability to model the data.

Transformer updating system 102 may execute instructions for updating transformer machine learning models to account for relative timing between events. Transformer updating system 102 may include software, hardware, or a combination of the two. For example, communication subsystem 112 may include a network card (e.g., a wireless network card and/or a wired network card) that is associated with software to drive the card. In some embodiments, transformer updating system 102 may be a physical server or a virtual server that is running on a physical computer system. In some embodiments, transformer updating system 102 may be configured on a client device (e.g., a laptop computer, a smartphone, a desktop computer, an electronic tablet, or another suitable client device).

Data node 104 may store various data, including one or more machine learning models, training data, communications, and/or other suitable data. In some embodiments, data node 104 may also be used to train machine learning models. Data node 104 may include software, hardware, or a combination of the two. For example, data node 104 may be a physical server or a virtual server that is running on a physical computer system. In some embodiments, transformer updating system 102 and data node 104 may reside on the same hardware and/or the same virtual server/computing device. Network 150 may be a local area network, a wide area network (e.g., the internet), or a combination of the two.

In some embodiments, transformer updating system 102 (e.g., communication subsystem 112) may retrieve a transformer model. For example, the transformer model may be trained based on input events, such as events relating to a person's behavior over time. As an illustrative example, a transformer model may be trained to model and predict events (e.g., actions, activities, transactions, or other events) associated with a person based on a sequence of events performed by the person in the past. The transformer model may be trained to model behavior of a person (e.g., a member of an organization) so that certain actions can be taken in advance of predicted events (e.g., retention efforts, communicative strategies, or other actions). The events on which the transformer model is trained may include a first event associated with a first time and second events associated with second times. In some embodiments, the first event may be a query event and the second events may be key events. A query may be a representation that is used to score how much focus should be put on other parts of the input data (e.g., keys). A query may thus represent the current event that the transformer model is considering. Each key may then be weighted based on the focus the transformer model places on each key relative to the query.

In some embodiments, the first event in the input data may be projected into a query space to generate the query event and each second event may be projected into a key space to generate each key event. Each input data element, such as an event, may be represented as a vector. To project the input data into query space or key space, the model may apply a learned linear transformation, such as a matrix multiplication, where the input vectors may be multiplied by a weight matrix. These weights, learned during the training process, may be specific to the task the model is trained for. The result of this multiplication may be a set of vectors, each representing a query. Each query vector corresponds to an element in the input data and may contain information about that element in a form suitable for the attention mechanism of the transformer. The process may be repeated to generate keys using different learned weight matrices. The query vectors may then be used in the attention mechanism, where they interact with key vectors to determine the focus level on each part of the input. In some embodiments, transformer updating system 102 may treat each event within input data as the query in turn, while treating the remaining events as keys.

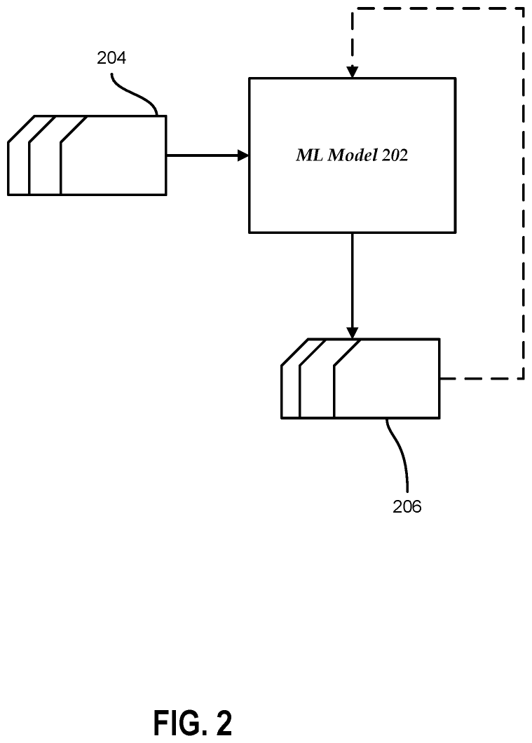

FIG. 2 illustrates an exemplary machine learning model 202, in accordance with one or more embodiments. In some embodiments, machine learning model 202 may be included in machine learning subsystem 114 or may be associated with machine learning subsystem 114. Machine learning model 202 may take input 204 (e.g., event data relating to a person) and may generate outputs 206 (e.g., a model of the person's behavior). The output parameters may be fed back to the machine learning model as inputs to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

In some embodiments, machine learning model 202 or machine learning subsystem 114 may include a transformer machine learning model. Transformer models may process and analyze large amounts of data through deep learning techniques. Typically, a transformer model may begin by ingesting massive datasets, which can include text, images, or other types of information. The transformer then uses this data to train itself by learning patterns, relationships, and structures within the data. One of the key features of transformer models is their use of attention mechanisms. This approach allows the transformer to focus on different parts of the input data when making predictions or generating responses. For instance, in NLP, a transformer model may pay more attention to specific words or phrases in a sentence that are crucial for understanding the context and meaning. Another aspect of these models is their ability to handle sequential data, such as text or time-series data, in a way that does not rely on the sequential processing used in other types of models. Instead, transformers can process entire sequences of data simultaneously, which often results in more efficient and effective learning. Since transformer models do not inherently capture the sequential nature of the input, positional encodings may be added to the input embeddings to provide information about the position of words in the sequence. Transformers often utilize an encoder-decoder architecture, where the encoder processes the input sequence, and the decoder generates the output sequence. This architecture may be used for sequence-to-sequence tasks like machine translation and text summarization.

The training process of a transformer model typically involves adjusting the model's internal parameters to minimize the difference between its outputs and the correct answers or desired outcomes. This process, known as optimization, may rely on various algorithms. Once trained, transformer models may perform a wide range of tasks, such as language translation, content generation, image recognition, and more. In some embodiments, transformer models may be adapted to other contexts as well. For example, to predict events, for example, transformers may analyze data, identifying patterns and relationships that may not be immediately apparent. They may do this by focusing on specific segments of the data that are more relevant for making accurate predictions. By ingesting large datasets that capture different aspects of behavior, such as many different historical events, these models can learn underlying patterns and decision-making processes. This learning may enable them to simulate or predict future events under varying conditions.

Returning to FIG. 1, transformer updating system 102 (e.g., embedding subsystem 116) may generate event embeddings. Event embeddings may be representations of events in a continuous vector space. They may be similar to word embeddings in NLP, where words are represented as dense vectors in a continuous space, capturing semantic relationships between words. In the context of event data or sequences, event embeddings may encode information about events, their relationships, and contextual dependencies. These embeddings may be created using various techniques and may be used in sequential data analysis, recommendation systems, time-series analysis, and other applications dealing with event sequences. In some embodiments, an event embedding may be generated using sequential models (e.g., Recurrent Neural Networks (RNNs), transformers, etc.) Models such as RNNs or transformer architectures may learn embeddings from event sequences by processing them sequentially. These models may capture dependencies between events and generate embeddings based on the sequence context. Temporal Convolutional Networks (TCNs) use convolutional operations to learn event embeddings by considering temporal dependencies in event sequences. Event data may also be represented as a graph, where events are nodes, and relationships between events are edges. Graph embedding techniques may aim to learn representations for events based on their connectivity and interactions in the graph. Event embeddings may capture various properties of events, such as event types, temporal relationships, contextual information, and dependencies among events in a sequence. These embeddings may be used in downstream tasks like event prediction, anomaly detection, recommendation systems, and more, providing a compact and meaningful representation of event data.

Embedding subsystem 116 may generate event embeddings for the input events. For example, the input events may include a first event (e.g., a query event) and second events (e.g., key events). Embedding subsystem 116 may align the query event with a query event embedding and the key events with key event embeddings. For example, the query event and each key event may be converted into a high-dimensional vector using a learned embedding layer. This initial embedding may capture the essential features of each event in a format the transformer can process. Once the initial embeddings are created, the transformer may apply separate linear transformations to these embeddings to produce the query embedding and the key embeddings. These transformations may be facilitated by learned weights that are specific to each type of vector, as previously discussed. For the query and key vectors, these transformations may be designed to prepare the embeddings for the attention mechanism. The query embeddings may represent the elements for which the model is trying to determine relevance, while the key embeddings may correspond to the elements against which the query is compared. The model may then use these query and key embeddings in the attention mechanism, as will be discussed in detail below. In some embodiments, the query and key embeddings may represent, for a corresponding event, how that event would fit into a sequence of other events. For example, the embeddings may represent the context in which each corresponding event occurs.

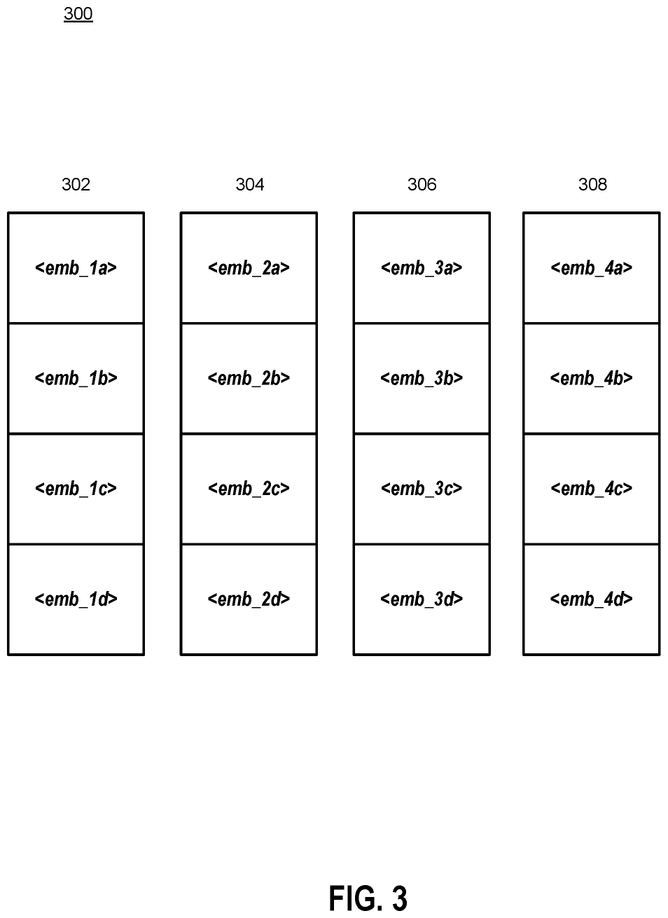

FIG. 3 illustrates event embeddings 300, in accordance with one or more embodiments. For example, event embeddings 300 may include event embedding 302, event embedding 304, event embedding 306, and event embedding 308. In some embodiments, event embedding 302 may correspond to a first event (e.g., a query event), event embedding 304 may correspond to a second event (e.g., a key event), event embedding 306 may correspond to a third event (e.g., a key event), and event embedding 308 may correspond to a fourth event (e.g., a key event). In some embodiments, each event embedding may include values that represent various aspects and features of the corresponding event, capturing both explicit and implicit characteristics that define the event. The embeddings may be high-dimensional vectors where each dimension may encode different attributes or nuances of the corresponding event. As an illustrative example, each event embedding may encapsulate information such as the time and location of an event associated with a person (e.g., a member of an organization), its participants, its type or category (e.g., credit card transaction, default, cancellation of a card, credit check, etc.), and other relevant contextual details. For example, in each embedding of an event, certain dimensions may implicitly encode the significance or impact of the event, based on how similar events have been perceived or categorized in the training data. Another dimension may encode relationships between the events, such as causality or correlation, learned through the transformer's exposure to sequences or clusters of events in the data. In some embodiments, plotting event embedding 302, event embedding 304, event embedding 306, and event embedding 308 may reveal that similar events are plotted close to each other while events with vastly different characteristics are plotted farther apart. In some embodiments, event embeddings 300 may include different event embeddings or event embeddings having different dimensions.

Returning to FIG. 1, machine learning subsystem 114 may input the event embeddings into the transformer model. In some embodiments, this may cause the transformer model to perform a transformation on the event embeddings. In particular, machine learning subsystem 114 may feed the embeddings into the multiple layers of the transformer model for further processing. Each layer in the transformer model may be designed to perform a series of transformations on these embeddings, enabling the model to extract and refine the information encoded in the input data. An attention mechanism of the transformer may dynamically weigh the importance or relevance of different parts of the input sequence. Unlike traditional models that process data in a fixed manner, the attention mechanism in transformers may selectively focus on specific elements of the input sequence that are more relevant for a given task. This ability to focus selectively allows the transformer to handle complex dependencies and relationships within the data. For example, the attention mechanism can weigh the influence of each event in relation to others, regardless of their position in the sequence, enabling a more nuanced understanding and processing of the input. Furthermore, as the embeddings pass through successive layers of the transformer, each layer may refine and reshape these representations, building upon the transformations performed by previous layers. This layered processing allows the model to capture and encode increasingly abstract and complex relationships within the data. By the time the embeddings have passed through all the layers, they have been transformed into a representation of the original input that captures a deep understanding of the data.

In some embodiments, the transformer may perform a transformation on the embeddings. A transformation may refer to various operations applied to the input event embeddings through the layers of the transformer model. Transformations may involve linear transformations, activation functions, or other functions. The transformer may perform a transformation on the embedding involving dot products. For example, the transformer may involve taking a dot product of a first event embedding (e.g., query event embedding) with each of the second event embeddings (e.g., key event embeddings). A dot product may be an operation that takes two equal-length sequences of numbers (usually coordinate vectors) and returns a single number. This operation involves multiplying corresponding elements of the vectors and then summing those products. The dot product thus transforms a pair of vectors into a single scalar value. The dot product is used by the transformer to compute the similarity between query and key embeddings. This similarity score is crucial to determining how much attention or weight should be given to different events of the input events.

In some embodiments, the transformation of the embeddings may generate an attention matrix of attention values. Attention values may refer to the importance or weight assigned to each key event embedding relative to a query event embedding. An attention mechanism in the transformer model may calculate attention scores that determine how much focus each event should receive concerning other events in the same input. For example, for each event in the input, the model may calculate scores by performing a dot product between the event's embedding and the embeddings of other events in the input. These scores may represent the importance or relevance of other events relative to the current event.

To generate the attention matrix, the transformer may take the dot product of the query embeddings with the key embeddings. By multiplying corresponding elements of these embeddings and summing the results, the model computes a scalar value for each pair of query and key. The resulting values from these dot product operations form the attention matrix. Each entry in this matrix may represent the attention score or the degree of relevance between a specific query and a key. Each value may further indicate how much attention the query event should pay to that particular key event. The attention scores may be normalized, for example using a softmax function, to ensure that they form a valid probability distribution. For example, a softmax function may transform values within a vector into values that sum up to one. Thus, the softmax function converts each attention value into a format representing a relative relevance of a corresponding pair of events to each other. This normalization step may allow the transformer to focus more clearly on the most relevant parts of the input data.

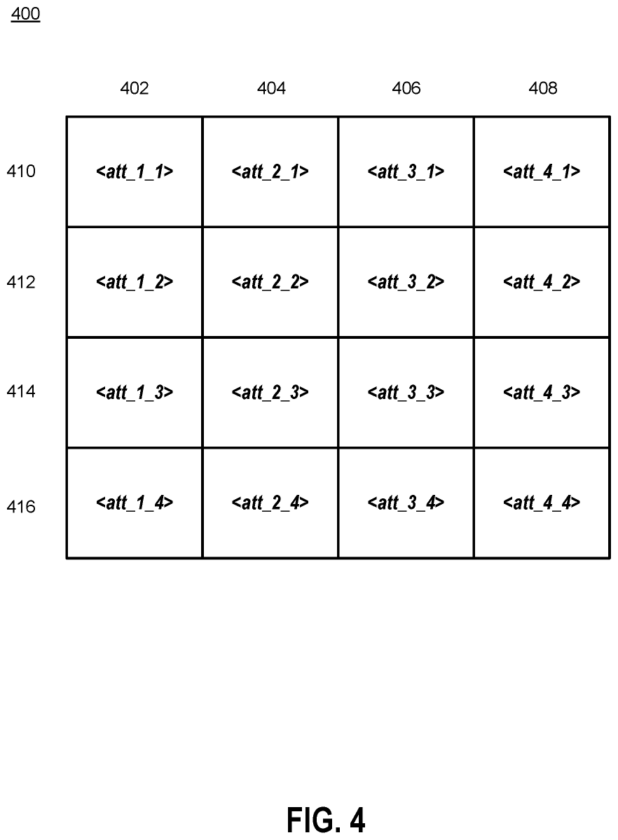

FIG. 4 illustrates an attention matrix 400, in accordance with one or more embodiments. In some embodiments, each entry of attention matrix 400 may represent a similarity between a query embedding and a key embedding. In some embodiments, attention matrix 400 may include column 402, column 404, column 406, and column 408, which may correspond to a first, second, third, and fourth key, respectively, and row 410, row 412, row 414, and row 416, which may correspond to a first, second, third, and fourth query, respectively. In some embodiments, the first entry of row 410 (e.g., <att_1_1>) may represent a similarity between a first query embedding (e.g., event embedding 302, as shown in FIG. 3) and a first key embedding (e.g., event embedding 304). A second entry (e.g., <att_2_1>) may represent a similarity between the first query embedding (e.g., event embedding 302) and a second key embedding (e.g., event embedding 306). A third entry (e.g., <att_3_1>) may represent a similarity between the first query embedding (e.g., event embedding 302) and a third key embedding (e.g., event embedding 308), and so on. In some embodiments, the process may be repeated for row 412 using a different event as the query event, and so on. In some embodiments, attention matrix 400 may have more columns and rows based on more event embeddings or fewer columns and rows based on fewer event embeddings.

As an illustrative example, a first query event may represent when a person defaulted on a credit card payment. The key events may include the person making various payments, checking their account, chatting with customer service, and performing other actions. In some embodiments, the first entry of row 410 (e.g., <att_1_1>) may represent a similarity between the first query embedding (e.g., representing the person defaulting on a payment) and a first key embedding (e.g., representing the person making a different payment). A second entry (e.g., <att_2_1>) may represent a similarity between the first query embedding (e.g., representing the person defaulting on a payment) and a second key embedding (e.g., representing the person checking their account). A third entry (e.g., <att_3_1>) may represent a similarity between the first query embedding (e.g., representing the person defaulting on a payment) and a third key embedding (e.g., representing the person chatting with a customer service chatbot), and so on.

Returning to FIG. 1, transformer updating system 102 (e.g., timing subsystem 118) may determine respective time differences between a first time of a first query event and each corresponding second time of key events. In some embodiments, time may be represented as a number of days since a common start point (e.g., Jan. 1, 1990). In some embodiments, time may be represented in a month, day, and year format. In some embodiments, time may include a time of day. In some embodiments, another format of time may be used. In some embodiments, multiple formats of time may be used at different steps and timing subsystem 118 may convert the times between formats. Timing subsystem 118 may calculate a first time difference between when a first query event (e.g., corresponding to event embedding 302) and a first key event (e.g., corresponding to event embedding 304) occurred. Timing subsystem 118 may calculate a second time difference between when the first query event (e.g., corresponding to event embedding 302) and a second key event (e.g., corresponding to event embedding 306) occurred, and so on. Timing subsystem 118 may repeat this process for each pair of events in the input events, treating each event in turn as the query.

In some embodiments, generating the attention values may involve aggregating the respective time differences and the transformations (e.g., dot products) in attention matrix 400. For example, timing subsystem 118 may adjust the transformation based on the respective time differences such that each attention value accounts for the corresponding respective time difference. For example, timing subsystem 118 may add each respective time difference to each corresponding attention value. For example, timing subsystem 118 may add, to a first dot product of a first query event embedding and a first key event embedding, a first time difference between the first query event and the first key event. Timing subsystem 118 may repeat this process for each pair of events. In some embodiments, timing subsystem 118 may subtract each respective time difference from each corresponding attention value. In some embodiments, timing subsystem 118 may perform the aggregation step on the non-normalized version of each attention value. For example, timing subsystem 118 may perform the aggregation step on each non-normalized attention value and machine learning subsystem 114 may then normalize the attention values following the aggregation step (e.g., using a softmax function). Once timing subsystem 118 has aggregated the respective time differences and the dot products, each attention value may indicate a weight of a corresponding key event of the plurality of key events relative to the query event, accounting for a respective time difference between the first time and a corresponding second time.

In some embodiments, generating the attention values may involve aggregating a function of the respective time differences and the transformation (e.g., dot products) in attention matrix 400. For example, the function may be an exponential decay function. An exponential decay function may include higher values for smaller time differences between times of corresponding events and lower values for larger time differences between times of corresponding events. The transformation may be adjusted by adding the exponential decay function to the dot products so that attention values for events that are closer together in time are increased by a greater amount than attention values for events that are farther apart in time. Aggregating the transformation and the respective time differences may thus involve adding the exponential decay function of the respective time differences to the transformation. In some embodiments, the function may be an exponential growth function. An exponential growth function may include lower values for smaller time differences between times of corresponding events and higher values for larger time differences between times of corresponding events. The transformation may be adjusted by subtracting the exponential growth function from the dot products so that attention values for events that are farther apart in time are decreased by a greater amount than attention values for events that are closer together in time. Aggregating the transformation and the respective time differences may thus involve subtracting the exponential growth function of the respective time differences from the transformation. In some embodiments, machine learning subsystem 114 may use another function. In some embodiments, machine learning subsystem 114 may use a combination of functions to adjust the transformation.

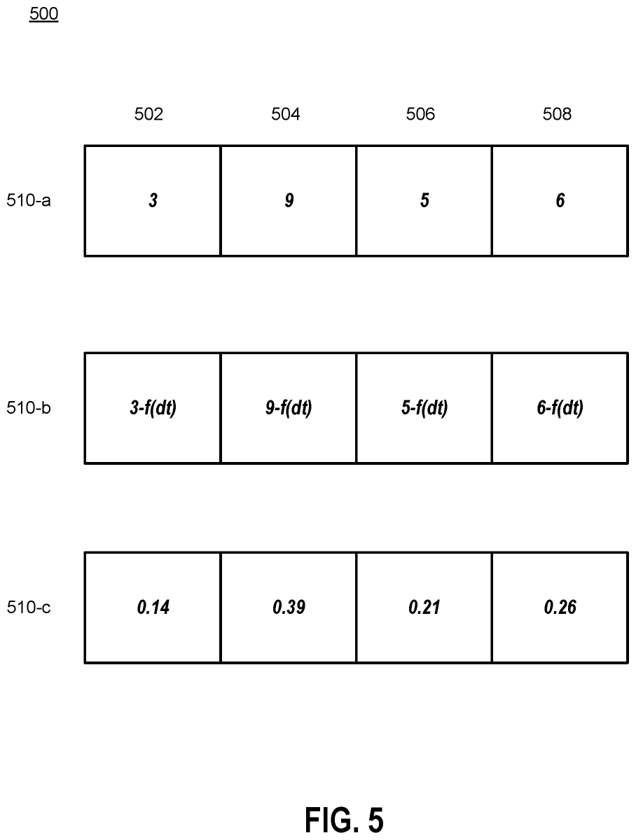

FIG. 5 illustrates operations 500 performed on a row of an attention matrix, in accordance with one or more embodiments. In some embodiments, row 510 a-c may correspond to row 410 of attention matrix 400, as shown in FIG. 4. In some embodiments, row 510 a-c may include column 502, column 504, column 506, and column 508. In some embodiments, row 510-a may represent row 510 a-c in a non-normalized state before an aggregation step has been performed. The values in row 510-a may thus represent dot products between a first query embedding and key embeddings, respectively. In some embodiments, row 510-b may represent timing subsystem 118 performing the aggregation step on row 510 a-c. For example, timing subsystem 118 may subtract a function of a respective time difference from each corresponding dot product in row 510-a. In some embodiments, row 510-c may represent the resulting values once they have been normalized. In some embodiments, each attention value in row 510-c may indicate a weight of a corresponding key event relative to the first query event, accounting for a respective time difference between a first time of the first query and a corresponding second time of a corresponding key. In some embodiments, machine learning subsystem 114 may update an attention matrix with the new attention values. For example, machine learning subsystem 114 may update row 410 of attention matrix 400, as shown in FIG. 4, with row 510-c, as shown in FIG. 5. Machine learning subsystem 114 may update each row of attention matrix 400 with the new attention values.

As an illustrative example, a first query event may represent when a person defaulted on a credit card payment. The key events may include the person making various payments, checking their account, chatting with customer service, and performing other actions. In some embodiments, the first entry of row 510-a (e.g., 3, as shown in FIG. 5, or <att_1_1>, as shown in FIG. 4) may represent a similarity between the first query embedding (e.g., representing the person defaulting on a payment) and a first key embedding (e.g., representing the person making a different payment), adjusted for a first time difference between the first query event and the first key event occurring. A second entry (e.g., 9, as shown in FIG. 5, or <att_2_1>, as shown in FIG. 4) may represent a similarity between the first query embedding (e.g., representing the person defaulting on a payment) and a second key embedding (e.g., representing the person checking their account), adjusted for a second time difference between the first query event and the second key event occurring. A third entry (e.g., 5, as shown in FIG. 5, or <att_3_1>, as shown in FIG. 4) may represent a similarity between the first query embedding (e.g., representing the person defaulting on a payment) and a third key embedding (e.g., representing the person chatting with a customer service chatbot), adjusted for a third time difference between the first query event and the third key event occurring, and so on.

In some embodiments, machine learning subsystem 114 may then update the transformer model with the attention values. For example, machine learning subsystem 114 may multiply each event embedding (e.g., event embeddings 300, as shown in FIG. 3) by its corresponding attention score from the updated attention matrix. This multiplication may scale the event embeddings based on how relevant they are for each query. The transformer then sums these scaled value embeddings for each query, resulting in a new set of embeddings. These new event embeddings are updated representations of the input events, recontextualized based on the attention scores. For example, the new event embeddings encompass differences in time between events.

In some embodiments, machine learning subsystem 114 may perform the same aggregation step discussed above at every layer of the transformer model. For example, timing subsystem 118 may subtract the same time difference values at every step because the time difference between a given pair of events stays the same. Machine learning subsystem 114 may thus aggregate the dot products at every layer of the transformer with the same time difference values. In this way, machine learning subsystem 114 may update the attention values for every layer of the transformer model. The transformer model may continuously refine its representations and interpretations of the input data using the updated attention values at every layer of the model. Through this mechanism, the transformer may dynamically adapt its processing while accounting for the differences in time between events.

As an illustrative example, communication subsystem 112 may retrieve a transformer model. For example, the transformer model may be trained based on input events, such as events relating to a person's behavior over time. The transformer model may be trained to model and predict events (e.g., actions, activities, transactions, or other events) associated with a person based on a sequence of events performed by the person in the past. Embedding subsystem 116 may generate event embeddings for input events. Each event embedding may encapsulate information such as the time and location of an event associated with a person (e.g., a member of an organization), its participants, its type or category (e.g., credit card transaction, default, cancellation of a card, credit check, etc.), and other relevant contextual details. The transformer may perform a transformation on the embeddings involving dot products. In some embodiments, the transformations of the embeddings may generate an attention matrix.

Generating the attention values within the attention matrix may involve adjusting the transformations by respective time differences between corresponding pairs of events. For example, the events may include a person defaulting on a credit card payment, making various other payments, checking their account, chatting with customer service, and performing other actions. In some embodiments, a first attention value may represent a similarity between a first embedding (e.g., representing the person defaulting on a payment) and a second embedding (e.g., representing the person making a different payment), adjusted for a first time difference between the person defaulting on the payment and making the different payment. A second attention value may represent a similarity between the first embedding (e.g., representing the person defaulting on a payment) and a third embedding (e.g., representing the person checking their account), adjusted for a second time difference between the person defaulting on the payment and checking their account, and so on. For example, the person may have checked their account several months before they defaulted on their payment but they may have made a different payment the day before defaulting. The attention value representing the relevance of the different payment to the default may thus be increased by a greater amount than the attention value representing the relevance of the account check to the default. Machine learning subsystem 114 may update the transformer model using the attention values so that the transformer model learns to place less weight on events that occurred farther apart in time and to rely more heavily on events that occurred closer together in time. This updating enables transformer models to adapt to contexts in which understanding the relative timing of data is crucial to a transformer's ability to model the data.

### Computing Environment

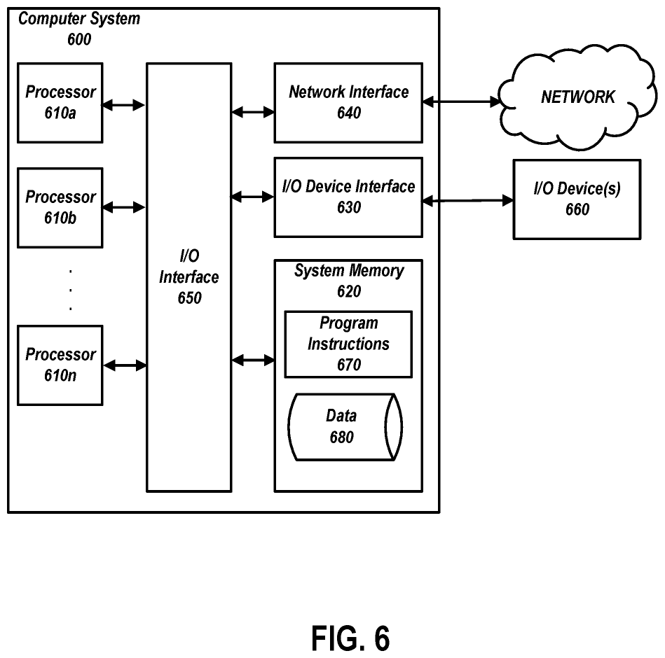

FIG. 6 shows an example computing system 600 that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example, an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computing system 600 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

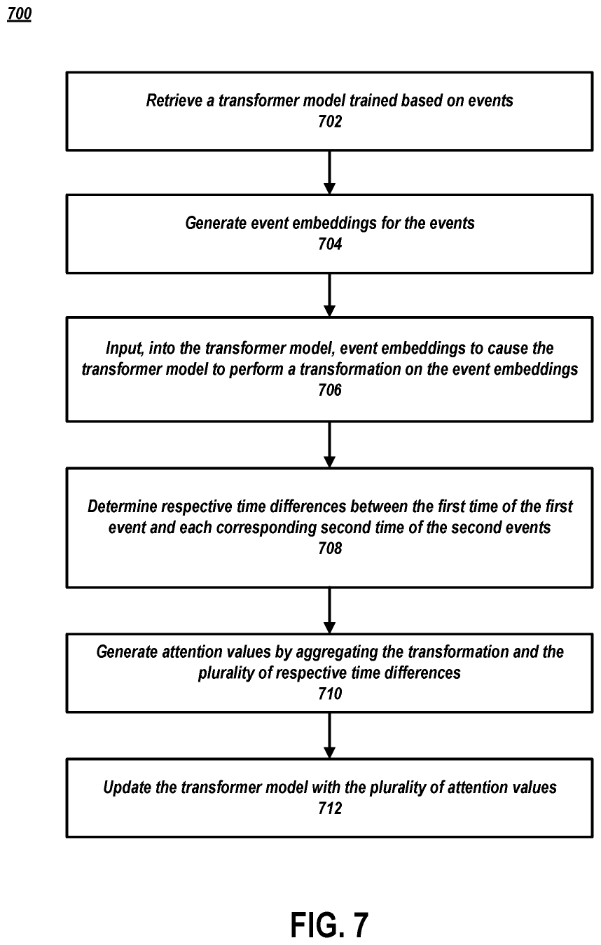

FIG. 7 shows a flowchart of the process 700 for updating transformer machine learning models to account for relative timing, in accordance with one or more embodiments. For example, the system may use process 700 (e.g., as implemented on one or more system components described above) to update attention weights used by transformer machine learning models based on relative times of events.

At 702, transformer updating system 102 (e.g., using one or more of processors 610a-610n) may retrieve a transformer model trained based on events. The events may include a first event associated with a first time and second events associated with second times. Transformer updating system 102 may retrieve the transformer model using one or more of system memory 620, data 680, or the network.

At 704, transformer updating system 102 (e.g., using one or more of processors 610a-610n) may generate event embeddings for the events. For example, transformer updating system 102 may generate a first event embedding corresponding to the first event and second event embeddings corresponding to the second events. In some embodiments, transformer updating system 102 may generate the event embeddings using one or more of processors 610a-610n.

At 706, transformer updating system 102 (e.g., using one or more of processors 610a-610n) may input the event embeddings into the transformer model. In some embodiments, inputting the event embeddings into the transformer model may cause the transformer model to perform a transformation on the event embeddings. For example, the transformation may be a dot product of the first event embedding with each of the second event embeddings. In some embodiments, transformer updating system 102 may input the event embeddings into the transformer model using one or more of processors 610a-610n.

At 708, transformer updating system 102 (e.g., using one or more of processors 610a-610n) may determine respective time differences between the first time of the first event and each corresponding second time of the second events. For example, transformer updating system 102 may determine a time difference between each pair of events. In some embodiments, transformer updating system 102 may determine the respective time differences using one or more of processors 610a-610n.

At 710, transformer updating system 102 (e.g., using one or more of processors 610a-610n) may generate attention values by aggregating the transformation and the respective time differences. In some embodiments, transformer updating system 102 may aggregate the transformation with a function of the respective time differences. Each attention value may indicate a weight of a corresponding second event relative to the first event. Each attention value may account for a respective time difference between the first time and a corresponding second time. In some embodiments, transformer updating system 102 may generate the attention values using one or more of processors 610a-610n.

At 712, transformer updating system 102 (e.g., using one or more of processors 610a-610n) may update the transformer model with the plurality of attention values. For example, updating the transformer model with the attention values may involve aggregating the respective time differences with transformations at all layers of the transformer model. In some embodiments, transformer updating system 102 may update the transformer model using one or more of processors 610a-610n.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising retrieving a transformer model trained based on a plurality of events, the plurality of events comprising a first event associated with a first time and a plurality of second events associated with a plurality of second times, generating a plurality of event embeddings for the plurality of events, inputting, into the transformer model, the plurality of event embeddings to cause the transformer model to perform a transformation on the plurality of event embeddings, determining a plurality of respective time differences between the first time of the first event and each corresponding second time of the plurality of second events, generating a plurality of attention values by aggregating the transformation and the plurality of respective time differences, and updating the transformer model with the plurality of attention values.

2. The method of the preceding embodiment, wherein aggregating the transformation and the plurality of respective time differences comprises adjusting the transformation based on the plurality of respective time differences such that each attention value accounts for a respective time difference between the first time and a corresponding second time.

3. The method of any one of the preceding embodiments, wherein aggregating the transformation and the plurality of respective time differences comprises aggregating the transformation and a function of the plurality of respective time differences.

4. The method of any one of the preceding embodiments, wherein the function is an exponential decay function and wherein aggregating the transformation and the plurality of respective time differences comprises adding the function of the plurality of respective time differences to the transformation.

5. The method of any one of the preceding embodiments, wherein the function is an exponential growth function and wherein aggregating the transformation and the plurality of respective time differences comprises subtracting the function of the plurality of respective time differences from the transformation.

6. The method of any one of the preceding embodiments, wherein the transformation comprises a plurality of dot products of a first event embedding corresponding to the first event with each of a plurality of second event embeddings corresponding to the plurality of second events.

7. The method of any one of the preceding embodiments, wherein generating the plurality of attention values further comprises normalizing, using a softmax function, values generated by aggregating the transformation and the plurality of respective time differences.

8. The method of any one of the preceding embodiments, wherein updating the transformer model with the plurality of attention values comprises aggregating the plurality of respective time differences with a plurality of transformations at a plurality of layers of the transformer model.

9. The method of any one of the preceding embodiments, wherein the first event is a query event and wherein the plurality of second events is a plurality of key events, wherein each key event is weighted relative to the query event.

10. The method of any one of the preceding embodiments, further comprising, for each event of the plurality of events inputting, into the transformer model, the plurality of event embeddings to cause the transformer model to perform a transformation on each event embedding corresponding to each event relative to each other event embedding of the plurality of event embeddings, determining a corresponding plurality of time differences between a time of each event and each corresponding time of each other event of the plurality of events, and generating a corresponding plurality of attention values by aggregating the transformation and the corresponding plurality of time differences.

11. The method of any one of the preceding embodiments, wherein updating the transformer model further comprises aggregating, for each event of the plurality of events, the corresponding plurality of time differences with a plurality of transformations at a plurality of layers of the transformer model.

12. One or more non-transitory, machine-readable media storing instructions that, when executed by one or more data processing apparatuses, cause operations comprising those of any of embodiments 1-11.

13. A system comprising one or more processors and memory storing instructions that, when executed by the processors, cause the processors to effectuate operations comprising those of any of embodiments 1-11.

14. A system comprising means for performing any of embodiments 1-11.

15. A system comprising cloud-based circuitry for performing any of embodiments 1-11.

What is claimed is:

1. A system for updating transformer machine learning models to account for relative timing of events, the system comprising:
at least one processor, at least one memory, and computer-readable media having computer-executable instructions stored thereon, the computer-executable instructions, when executed by the at least one processor, causing the system to perform operations comprising:
retrieving a transformer model trained based on a plurality of events, the plurality of events comprising a query event associated with a first time and a plurality of key events associated with a plurality of second times;
generating a plurality of event embeddings comprising a query event embedding corresponding to the query event and a plurality of key event embeddings corresponding to the plurality of key events;
inputting, into the transformer model, the plurality of event embeddings to cause the transformer model to perform a transformation on the plurality of event embeddings, the transformation comprising a plurality of dot products of the query event embedding with each of the plurality of key event embeddings;
determining a plurality of respective time differences between the first time of the query event and each corresponding second time of the plurality of key events;
generating a plurality of attention values by aggregating, with the plurality of dot products, a function of the plurality of respective time differences, each attention value indicating a weight of a corresponding key event of the plurality of key events relative to the query event, and each attention value accounting for a respective time difference between the first time and a corresponding second time, wherein the function comprises an exponential decay function; and
updating the transformer model with the plurality of attention values.

2. A method comprising:
retrieving a transformer model trained based on a plurality of events, the plurality of events comprising a first event associated with a first time and a plurality of second events associated with a plurality of second times;
generating a plurality of event embeddings for the plurality of events;
inputting, into the transformer model, the plurality of event embeddings to cause the transformer model to perform a transformation on the plurality of event embeddings;
determining a plurality of respective time differences between the first time of the first event and each corresponding second time of the plurality of second events;
generating a plurality of attention values by aggregating the transformation and the plurality of respective time differences; and
updating the transformer model with the plurality of attention values.

3. The method of claim 2, wherein aggregating the transformation and the plurality of respective time differences comprises adjusting the transformation based on the plurality of respective time differences such that each attention value accounts for a respective time difference between the first time and a corresponding second time.

4. The method of claim 2, wherein aggregating the transformation and the plurality of respective time differences comprises aggregating the transformation and a function of the plurality of respective time differences.

5. The method of claim 4, wherein the function is an exponential decay function and wherein aggregating the transformation and the plurality of respective time differences comprises adding the function of the plurality of respective time differences to the transformation.

6. The method of claim 4, wherein the function is an exponential growth function and wherein aggregating the transformation and the plurality of respective time differences comprises subtracting the function of the plurality of respective time differences from the transformation.

7. The method of claim 2, wherein the transformation comprises a plurality of dot products of a first event embedding corresponding to the first event with each of a plurality of second event embeddings corresponding to the plurality of second events.

8. The method of claim 2, wherein generating the plurality of attention values further comprises normalizing, using a softmax function, values generated by aggregating the transformation and the plurality of respective time differences.

9. The method of claim 2, wherein updating the transformer model with the plurality of attention values comprises aggregating the plurality of respective time differences with a plurality of transformations at a plurality of layers of the transformer model.

10. The method of claim 2, wherein the first event is a query event and wherein the plurality of second events is a plurality of key events, wherein each key event is weighted relative to the query event.

11. The method of claim 2, further comprising, for each event of the plurality of events:
inputting, into the transformer model, the plurality of event embeddings to cause the transformer model to perform a transformation on each event embedding corresponding to each event relative to each other event embedding of the plurality of event embeddings;
determining a corresponding plurality of time differences between a time of each event and each corresponding time of each other event of the plurality of events; and
generating a corresponding plurality of attention values by aggregating the transformation and the corresponding plurality of time differences.

12. The method of claim 11, wherein updating the transformer model further comprises aggregating, for each event of the plurality of events, the corresponding plurality of time differences with a plurality of transformations at a plurality of layers of the transformer model.

13. One or more non-transitory, computer-readable media storing instructions that, when executed by one or more processors cause the one or more processors to perform operations comprising:
retrieving a transformer model trained based on a plurality of events, the plurality of events comprising a first event associated with a first time and a plurality of second events associated with a plurality of second times;
generating a plurality of event embeddings for the plurality of events;
inputting, into the transformer model, the plurality of event embeddings to cause the transformer model to perform a transformation on the plurality of event embeddings;
determining a plurality of respective time differences between the first time of the first event and each corresponding second time of the plurality of second events;
generating a plurality of attention values by aggregating the transformation and the plurality of respective time differences; and
updating the transformer model with the plurality of attention values.

14. The one or more non-transitory, computer-readable media of claim 13, wherein aggregating the transformation and the plurality of respective time differences comprises adjusting the transformation based on the plurality of respective time differences such that each attention value accounts for a respective time difference between the first time and a corresponding second time.

15. The one or more non-transitory, computer-readable media of claim 13, wherein aggregating the transformation and the plurality of respective time differences comprises aggregating the transformation and a function of the plurality of respective time differences.

16. The one or more non-transitory, computer-readable media of claim 15, wherein the function is an exponential decay function and wherein aggregating the transformation and the plurality of respective time differences comprises adding the function of the plurality of respective time differences to the transformation.

17. The one or more non-transitory, computer-readable media of claim 15, wherein the function is an exponential growth function and wherein aggregating the transformation and the plurality of respective time differences comprises subtracting the function of the plurality of respective time differences from the transformation.

18. The one or more non-transitory, computer-readable media of claim 13, wherein the transformation comprises a plurality of dot products of a first event embedding corresponding to the first event with each of a plurality of second event embeddings corresponding to the plurality of second events.

19. The one or more non-transitory, computer-readable media of claim 13, wherein generating the plurality of attention values further comprises normalizing, using a softmax function, values generated by aggregating the transformation and the plurality of respective time differences.

20. The one or more non-transitory, computer-readable media of claim 13, wherein updating the transformer model with the plurality of attention values comprises aggregating the plurality of respective time differences with a plurality of transformations at a plurality of layers of the transformer model.
